(19) United States
(12) Patent Application Publication
(10) Pub. No.: US 2009/0268072 A1
(43) Pub. Date: Oct. 29, 2009

(54) SOLID-STATE IMAGING DEVICE, DRIVING METHOD THEREOF, AND CAMERA

(75) Inventors: Kazuya MAKIYAMA, Osaka (JP); Akiyoshi KOHNO, Kanagawa (JP); Sei SUZUKI, Osaka (JP); Akira TSUKAMOTO, Osaka (JP)

Correspondence Address: GREENBLUM & BERNSTEIN, P.L.C., 1950 ROLAND CLARKE PLACE, RESTON, VA, 20191, US

(73) Assignee: Panasonic Corporation, Osaka (JP)

(21) Appl. No.: 12/427,266

(22) Filed: Apr. 21, 2009

(30) Foreign Application Priority Data
Apr. 25, 2008 (JP) 2008-116132

(51) Int. Cl. H04N 5/335

(52) U.S. Cl. 348/311; 348/E05.091

(57) ABSTRACT

To provide a solid-state imaging device which suppresses light emission caused by hot electrons, and reduces the difference in the impact of heat emission between fields. In the solid-state imaging device in the present invention, the final-stage source-follower circuit within the output circuit includes a drive transistor and a load transistor connected to the drive transistor, and, by applying, to the load transistor, a control signal having different levels for a first period including a charge sweep-out period and an exposure period of the light-receiving elements in a signal outputting period, and a second period which is a period excluding the charge sweep-out period from the signal outputting period, the source-to-drain voltage of the final-stage drive transistor in the first period is made lower than the source-to-drain voltage in the second period.

### BACKGROUND OF THE INVENTION

(1) Field of the Invention

The present invention relates to a solid-state imaging device, a driving method thereof, and a camera.

(2) Description of the Related Art

The demand for Charge-Coupled Device (CCD) solid-state imaging devices as imaging devices in Digital Still Cameras (DSC) or Digital Video Cameras (DVC) is increasing. Furthermore, the addition of a camera function even in mobile terminal apparatuses represented by mobile phones is also being required, and CCD solid-state imaging devices are being widely used.

However, since there is a tendency for dark current of light-receiving elements to increase following a rise in temperature in a CCD solid-state imaging device, there is localized image whitening and the occurrence of shading due to the increase of the dark current of light-receiving elements in the vicinity of a signal output unit, and thus causing image deterioration.

As a countermeasure, as shown in Japanese Unexamined Patent Application Publication No. 2003-283929 (Patent Reference 1), there is proposed: a solid-state image sensor having a control input terminal in the gates of load transistors M2, M4, and M6, and which is configured so that the current flowing to a signal output unit during an imaging exposure period is kept low and a vertical transmission pulse for driving vertical transmission units is applied as a control signal for operating the signal output unit normally during a period in which the imaging signal is outputted; and a driving method for the solid-state image sensor.

Hereinafter, the conventional technique shown in Patent Reference 1 shall be described using FIG. 12.

FIG. 12 is a circuit diagram showing the configuration of the signal output circuit of a conventional solid-state image sensor. As shown in the diagram, a control signal for controlling the current (the source current in this case) flowing in the signal output unit is inputted, in common, to the respective gate terminals (control input terminals) of the load transistors M2, M4, and M6. With this control signal, instead of a constant voltage, a control clock pulse substituted with a vertical transmission clock pulse Vφ supplied from a timing generator (TG) is directly applied. With this, the current flowing to the signal output unit during the signal accumulation period of a light-sensing unit is suppressed. In other words, the timing generator is made to function as a control signal application unit. The solid-state image sensor with such a configuration uses a driving method which sets the operation control pulse Vφ to a Low bias and cuts-off or reduces the source current control of the signal output unit, since the CCD signal outputting operation is not carried out during the signal accumulation period of the light-sensing unit, and thus there is no need to apply current for operating the signal output unit, and which sets the control clock pulse Vφ to a High bias and increases the current of the output unit to cause normal operation during the signal outputting period.

FIG. 13 is an explanatory diagram showing an example of the drive timing in the conventional technology shown in FIG. 12. (A) in FIG. 13 shows the operational timing of a mechanical shutter; (B) in FIG. 13 shows the operational timing a control pulse substituted with a vertical transmission clock pulse Vφ.

In FIG. 13, first, as shown in (A) in FIG. 13, in the imaging exposure period, the mechanical shutter is opened, signal charge is accumulated by the light-sensing unit, and subsequently the mechanical shutter is closed and the signal accumulation is ended. Next, during an unnecessary-charge sweep-out period, unnecessary charge remaining in the vertical transmission units is swept out by applying a high-speed vertical transmission clock pulse through the vertical transmission clock pulse Vφ, as shown in (B) in FIG. 13. In addition, in the next signal outputting period, the vertical transmission units read the signal charge accumulated in the light-sensing unit, and the vertical transmission units and a horizontal transmission unit transmit and output the signal charge to the signal output unit.

Subsequently, since the vertical transmission clock pulse Vφ applied, in common, to the respective gate terminals (control input terminals) of the load transistors M2, M4, and M6 during the imaging exposure period is set to a Low bias, it is possible to cut off the load transistors M2, M4, and M6 or reduce the source current. With this, it is possible to significantly reduce the power consumption of the signal output unit and reduce the amount of heat emitted in the signal output unit, and thus it is possible to reduce the image deterioration due to the localized image whitening and the occurrence of shading caused by the increase in the dark current of light-receiving elements in the vicinity of the signal output unit.

On the other hand, in the signal outputting period, the transmission clock pulse Vφ is set to a High bias, and the load transistors M2, M4, and M6 are set to ON. With this, in the signal outputting period, it is possible to cause the signal output unit to operate normally, and normal signal output operation can be carried out.

Furthermore, Japanese Unexamined Patent Application Publication No. 4-291581 (Patent Reference 2) discloses a technique of providing a current source of a final-stage source follower circuit of the signal output unit, outside the solid-state image sensor including light-receiving elements, to handle the image deterioration due to the localized image whitening and the occurrence of shading caused by the increase in the dark current of light-receiving elements in the vicinity of the signal output unit.

### SUMMARY OF THE INVENTION

However, in the conventional techniques disclosed in Patent Reference 1 and Patent Reference 2, there is the problem of picture quality deterioration due to the light emission phenomenon caused by hot electrons.

Describing the problem using FIG. 14, the light emission phenomenon caused by hot electrons is a phenomenon in which electrons moving from a source towards a drain cause impact ionization or avalanche multiplication due to the high electric field in the vicinity of the drain, electron-hole pairs are generated and, at this time, a part of the electrons and holes (hot electrons and holes) are injected into an oxide film and emit light.

The condition for hot carrier generation is determined by the condition for the voltage to be applied to a MOS transistor, for example, the source-to-drain voltage Vds. Since light emission intensity increases in proportion to the source-to-drain voltage Vds, light emission caused by the hot carrier cannot be suppressed even when the amount of current is reduced. The light emission phenomenon caused by hot electrons occurs depending on the condition for voltage in a peripheral circuit of the solid-state image sensor, such as the signal output unit shown in FIG. 12 or a bias voltage generating circuit as that shown in FIG. 15, and so on.

In addition, in the signal outputting period, although it is possible to suppress the impact of heat emission for a first field, the impact of heat emission cannot be suppressed from a second field to a final field, since the signal output unit operates normally, that is, the load transistors M2, M4, and M6 are ON and current is flowing. Thus, since the impact of heat emission is borne more heavily by a more-subsequent field, there is the problem of having differences in effectiveness between fields.

Furthermore, in the conventional techniques, image deterioration also arises due to the localized image whitening and occurrence of shading caused by the increase in the dark current of light-receiving elements due to the same heat emission as described above, even for the current source unit CS made up of a load transistor M7, a resistive element Rs and a resistive divider circuit, and a bias current generating circuit configured of a resistive element Rfuse.

Furthermore, the drain of the load transistor M7 is connected to a bias voltage generation point N, the source is grounded to GND via the resistive element Rs, and the resistive element Rfuse is made up of resistive elements Ra, Rb, Rc, and Rd which are connected in series between a power terminal VDD and the bias voltage generation point N. Both ends of the resistive element Rb are short circuited via a fuse element. The same is true for the resistive terminals Rc and Rd. By selectively cutting off these fuse elements, the resistance value of the resistive element Rfuse is adjusted as appropriate.

The resistive divider circuit divides into resistive elements R8 and R9 which are connected in series between the power terminal and a GND terminal, and voltage VCS obtained from the resistive divider circuit is applied to the load transistor M7 via a resistive element R7.

The electrical characteristic of the resistive elements Rfuse, Rs, R1, and R2, and the load transistor M7 is that they are configured so that a reference current flows in the resistive element Rfuse when voltage is applied to the power terminal VDD, and a voltage Vb which drops from the voltage applied to the power terminal VDD by as much as the voltage obtained by multiplying the reference current and the resistive element Rfuse. However, since the reference current flows at all times even during the imaging exposure period, there is the problem that the impact of heat emission cannot be suppressed with the conventional techniques.

In view of this, the present invention provides a solid-state imaging device, a driving method thereof, and a camera, for controlling light emission caused by hot electrons in the signal output unit, reducing the difference in the impact of heat emission between fields, and suppressing the deterioration of picture quality due to the light emission phenomenon caused by the hot electrons.

In order to achieve the aforementioned object, the solid-state imaging device in the present invention includes: a solid-state image sensor in which light-receiving elements are arrayed; an output circuit which includes at least one stage of a source follower circuit, and which receives a signal from each of said light receiving elements and outputs the received signal; and a buffer circuit which buffers with impedance conversion, an output signal from a source follower circuit which is a final stage in said output circuit, wherein said final-stage source follower circuit in said output circuit includes a drive transistor and a load transistor connected to said drive transistor, and a source-to-drain voltage of said drive transistor in the final stage during a first period is made lower than the source-to-drain voltage during a second period by applying, to said load transistor, a control signal having a different level for the first period and the second period, the first period including a charge sweep-out period and an exposure period of said light-receiving elements in a signal outputting period, and the second period being a period excluding the charge sweep-out period from the signal outputting period. Accordingly, since the majority of the current flowing to the output circuit flows to the final-stage source follower circuit, the high electric field in the vicinity of the drain is mitigated, the light emission phenomenon caused by hot electrons can be suppressed, and dark output can be reduced, by reducing the source-to-drain voltage of the final-stage drive transistor during the first period (in other words, the exposure period and the charge sweep-out period). As a result, it is possible to suppress image deterioration due to the light emission phenomenon caused by the hot electrons.

Furthermore, since the heat emission of the output circuit is reduced through the suppression of the current of the output circuit during the charge sweep-out period, it is possible to reduce the dark output due to heat emission in the field reading period following the charge sweep-out period, and reduce the difference in dark output due to heat emission differences between fields.

Here, said load transistor of said final-stage source follower circuit and said buffer circuit may be provided outside a semiconductor substrate on which said solid-state image sensor is formed. Accordingly, since the load transistor of the final-stage source follower circuit to which the most current flows among the output circuits, and the buffer circuit are provided outside of the semiconductor substrate, it is possible to shut out the negative effects of heat emission on the semiconductor substrate particularly during the second period.

Here, said load transistor may be a Junction Field-Effect Transistor, a gate of said load transistor may be grounded, a drain of said load transistor may be connected to an output signal line connected to a source of said drive transistor in the final stage, a source of the load transistor may be connected to a control signal line for transmitting the control signal, and the control signal may be a pulse signal which has a high level during the first period and has a low level during the second period. Accordingly, since the load transistor is a Junction field-effect transistor (JFET), thermal noise can be lowered. In addition, since the base is grounded, it is possible to stabilize the base potential at 0V and suppress noise generation. In addition, it is possible to reduce the number of parts of the circuit and miniaturize the circuit as compared to the case of using a bipolar transistor, for example.

Here, said load transistor may be a bipolar transistor, a collector of said load transistor may be connected to an output signal line connected to a source of said drive transistor in the final stage, an emitter of said load transistor may be grounded, a base of the load transistor may be connected to a control signal line for transmitting the control signal, and the control signal may be a pulse signal which has a low level during the first period and has a high level during the second period. Accordingly, since the load transistor is a grounded-emitter transistor, it can be made to operate even when the collector-emitter voltage Vce is low and loss of DC gain can be reduced. Furthermore, when many bipolar transistors are used in the external final-stage buffer circuit, designing the circuit, as a current source, is easy.

Here, said output circuit may further include, outside said semiconductor substrate, a resistive divider circuit which generates a constant voltage by resistive division, said load transistor may be a bipolar transistor, a collector of said load transistor may be connected to an output signal line connected to a source of said drive transistor in the final stage, an emitter of said load transistor may be connected to a control signal line for transmitting the control signal, a base of the load transistor may be supplied with the constant voltage from said resistive divider circuit, and the control signal may be a pulse signal which has a high level during the first period and has a low level during the second period. Accordingly, since the current fluctuation of the base is stabilized compared to the case of emitter-grounding, it is possible to suppress collector current fluctuation and noise.

Here, the solid-state imaging device may further include a bias voltage generating circuit which is provided on said semiconductor substrate, and which supplies a bias voltage to a peripheral circuit of said solid-state image sensor, wherein said bias voltage generating circuit may include a resistive circuit and a current source transistor and may output the bias voltage from a connection point between said resistive circuit and said current source transistor, said resistive circuit and said current source transistor being connected in series between a power line and a grounding line, and a current of said current source transistor during a first period may be made less than the current of said current source transistor during a second period by applying, to said current source transistor, the control signal having a different level for the first period and the second period. Accordingly, it is possible to lo suppress the light emission phenomenon caused by hot electrons and the heat emission in the bias voltage generating circuit, and reduce differences in hot electron light emission phenomena and heat emission suppression effectiveness between respective fields.

Here, the solid-state imaging device may further include a bias voltage generating circuit which is provided outside said semiconductor substrate, and which supplies a bias voltage to a peripheral circuit of said solid-state image sensor, wherein said bias voltage generating circuit may include a resistive circuit and a current source transistor and may output the bias voltage from a connection point between said resistive circuit and said current source transistor, said resistive circuit and said current source transistor being connected in series between a power line and a grounding line, and a current of said current source transistor during a first period, may be made less than the current of said current source transistor during a second period by applying, to said current source transistor, the control signal having a different level for the first period and the second period. Accordingly, since the current source transistor of the bias voltage generating circuit is provided outside of the semiconductor substrate, it is possible to shut out the negative effects of heat emission on the semiconductor substrate particularly during the second period.

Furthermore, the driving method of the solid-state imaging device and the camera of the present invention produce the same advantageous effects as described above.

According to the above-described configurations, it is possible to keep the current flowing to the signal output unit low and reduce the source-to-drain voltage Vds of the drive transistor of the source-follower circuit included in the signal output unit during the imaging exposure period and the unnecessary-charge sweep-out period, and, during the outputting period excluding the unnecessary-charge sweep-out period of the imaging signal, since the current that causes the signal output unit to operate normally flows, the light emission phenomenon caused by the hot electrons can be suppressed.

Furthermore, it is possible to keep the current flowing to the signal output unit low also during the unnecessary-charge sweep-out period, and, during the outputting period excluding the unnecessary-charge sweep-out period of the imaging signal, since the current that causes the signal output unit to operate normally flows, it is possible to reduce differences in hot electron light emission phenomena and heat emission suppression effectiveness between respective fields.

In addition, it is possible to suppress the hot electron light emission phenomenon and the heat emission generated from an internal peripheral circuit such as a bias voltage generating circuit aside from the substrate bias voltage generating circuit which influences the spectral characteristics of photodiodes aside from the signal output unit.

Furthermore, since the impact of the hot electron light emission phenomenon and the heat emission on images increases when the semiconductor substrate is thin, for example, equal or less than 600 μm, the light-sensing unit which accumulates the signal charge corresponding to the amount of received light, the charge transmission unit which transmits and outputs the signal charge accumulated by the light-sensing unit, and the signal output unit which converts the signal charge transmitted by the charge transmission unit into an imaging signal and outputs the imaging signal, are most effective when provided in a semiconductor substrate equal to or less than 600 μm.

### FURTHER INFORMATION ABOUT TECHNICAL BACKGROUND TO THIS APPLICATION

The disclosure of Japanese Patent Application No. 2008-116132 filed on Apr. 25, 2008 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a device outline diagram of a solid-state imaging device in an embodiment of the present invention;

FIG. 2 is a device configuration diagram showing a signal output circuit of a solid-state imaging device in a first embodiment of the present invention;

FIG. 3 is a diagram showing the drive timing for a solid-state image sensor in the first embodiment of the present invention;

FIG. 4 is a device configuration diagram showing a signal output circuit of a solid-state imaging device in a second embodiment of the present invention;

FIG. 5 is a diagram showing the drive timing for a solid-state image sensor in the second embodiment of the present invention;

FIG. 6 is a device configuration diagram showing a signal output circuit of the solid-state imaging device in a second embodiment of the present invention;

FIG. 7 is a device outline diagram of a solid-state imaging device in a third embodiment of the present invention.

FIG. 8 is an outline diagram showing a bias voltage generating circuit of a solid-state image sensor in the third embodiment of the present invention;

FIG. 9 is an outline diagram showing a bias voltage generating circuit of the solid-state image sensor in the third embodiment of the present invention;

FIG. 10 is a block diagram showing the configuration of a camera;

FIG. 11 is an external appearance diagram showing cameras;

FIG. 12 is an outline diagram showing the configuration of a heat emission-countermeasure in a signal output circuit of a solid-state image sensor in the conventional technique;

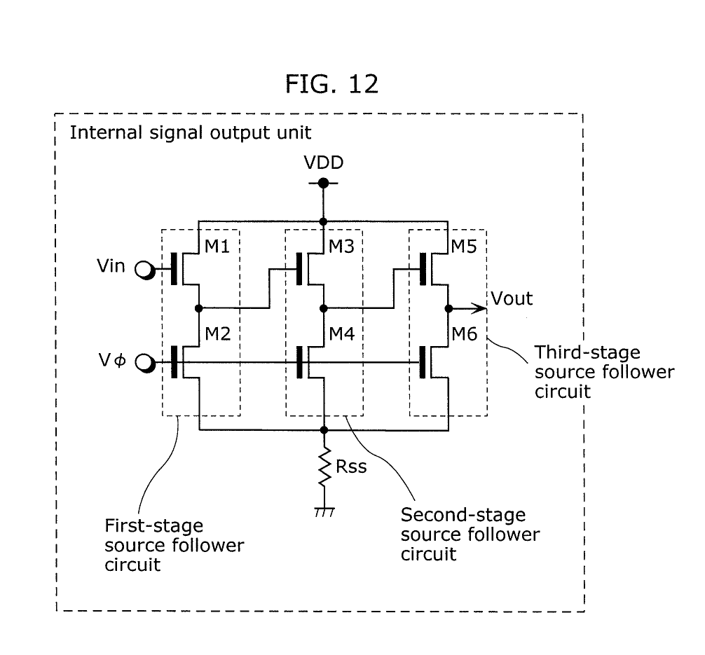

FIG. 13 is an outline diagram showing the drive timing for the heat emission-countermeasure in a solid-state image sensor in the conventional technique;

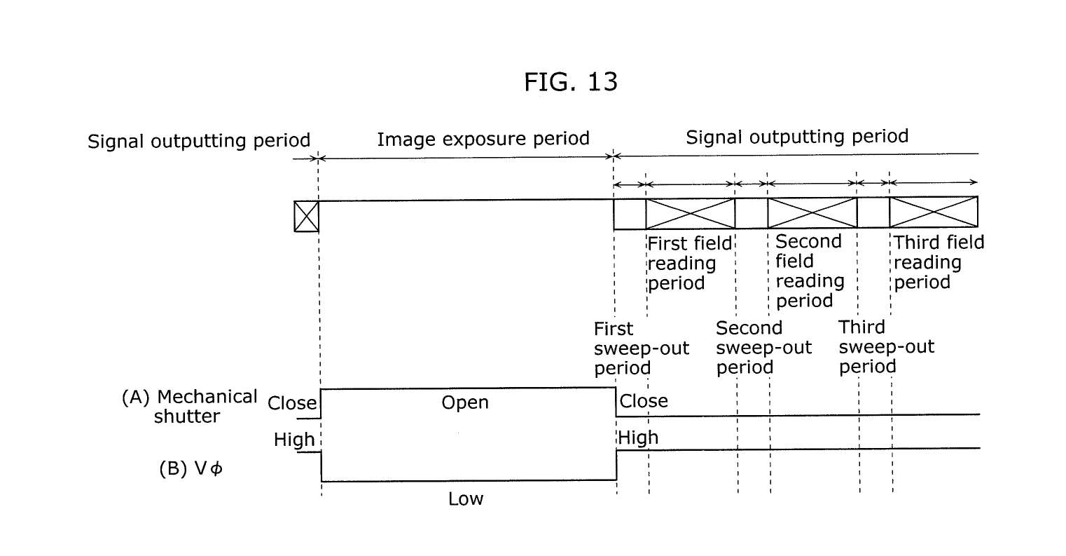

FIG. 14 is an outline diagram of an avalanche hot carrier (DAHC); and

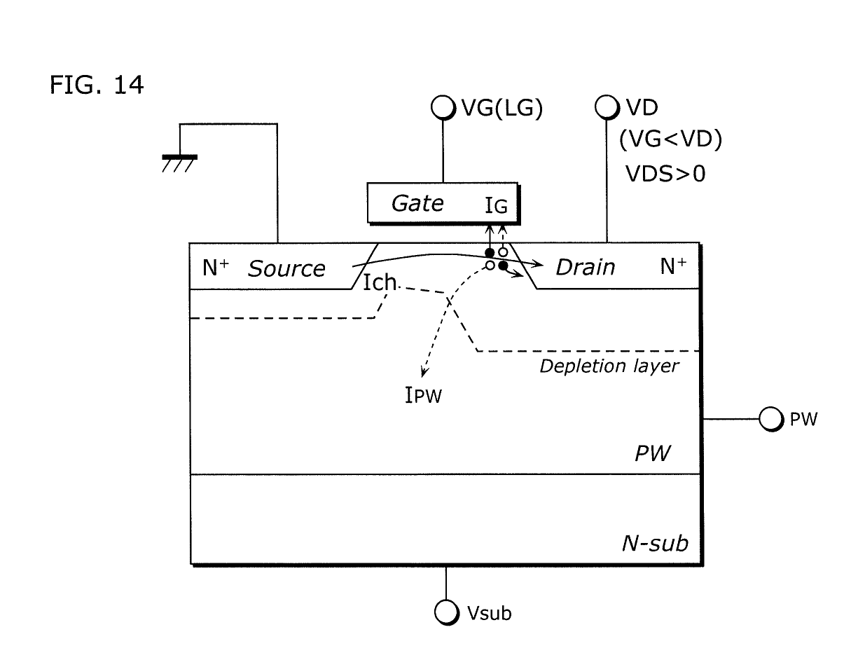

FIG. 15 is an outline diagram showing the configuration of a bias voltage generating circuit of a solid-state image sensor in the conventional technique.

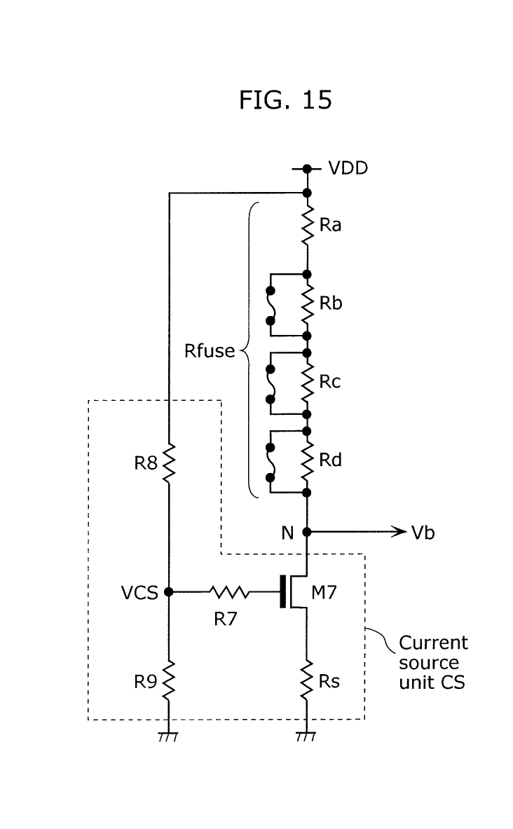

### DESCRIPTION OF THE PREFERRED EMBODIMENT(S)

### First Embodiment

Hereinafter, a solid-state imaging device in a first embodiment of the present invention shall be described with reference to the Drawings.

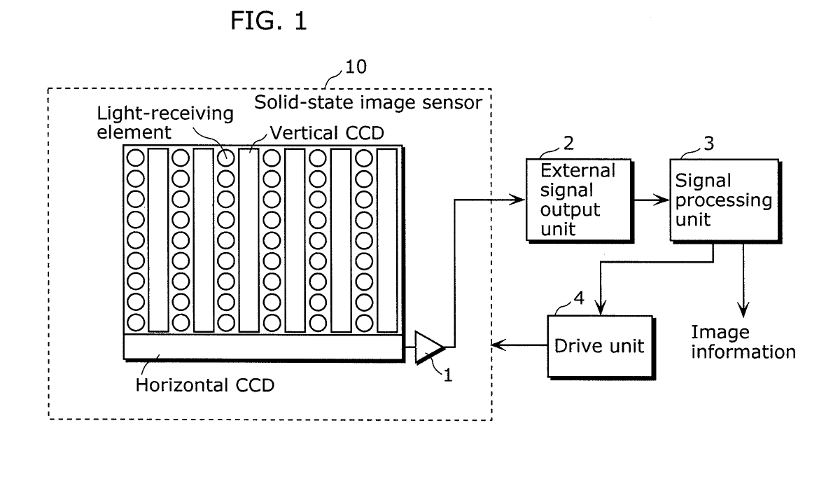

FIG. 1 is an outline diagram showing the configuration of the solid-state imaging device in a first embodiment of the present invention.

The solid-state imaging device in the present embodiment is built into the image-capturing device such as a video camera or a digital still camera, and outputs image information by photo-electric conversion of a subject image formed using a lens. As shown in FIG. 1, the solid-state imaging device includes a solid-state image sensor 10, an internal signal output unit 1, an external signal output unit 2, a signal processing unit 3, and a driving unit 4.

The solid-state image sensor 10 is a semiconductor device that is driven by the driving unit 4, and which outputs, in a predetermined sequence, from the internal signal output unit 1 to the external signal output unit 2, using plural vertical CCDs and one horizontal CCD, luminance signals generated by the projection of a subject formed using the lens (not illustrated) onto two-dimensionally arranged light-receiving elements and photo-electric conversion by the respective light-receiving elements. The internal signal output unit 1 is structured by removing, from the conventional signal output unit whose final stage is a source follower circuit, the load transistor which is the constant-current source unit within such source follower circuit. The load transistor that was removed from the internal signal output unit 1 is included in the external signal output unit 2.

Furthermore, although description is carried out in the present Specification using an example in which there is one horizontal CCD, there may be plural horizontal CCDs.

The external signal output unit 2 is connected between the solid-state image sensor 10 and the signal processing unit 3, and performs conversion necessary for outputting to the signal processing unit 3, on the output of the solid-state image sensor 10.

The signal processing unit 3 sends a drive instruction to the driving unit 4, and outputs image information by processing the luminance signals outputted from the external signal output unit 2.

The driving unit 4 drives the solid-state image sensor 10 based on the drive signal from the signal processing unit 3.

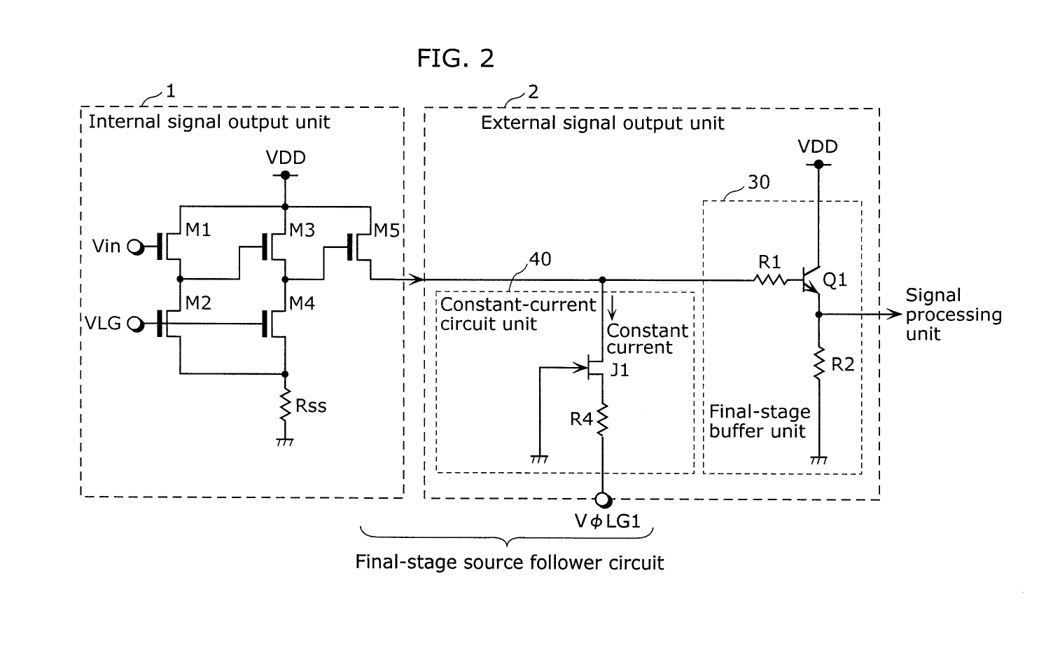

Next, FIG. 2 is an outline diagram showing the configuration of the internal signal output unit 1 and the external signal output unit 2 of the solid-state imaging device in the first embodiment of the present invention.

In FIG. 2, the internal signal output unit 1 is configured of three-stages of source follower circuits using MOS transistors M1 to M5. M1, M3, and M5 are drive transistors and M2 and M4 serve as load transistors which are the constant-current sources for lo operating the drive transistors M1 and M3. Furthermore, the drains of the respective drive transistors M1, M3, and M5 are connected to a power terminal VDD. Furthermore, the respective gates of the load transistors M2 and M4 are biased by a constant voltage of a VLG, and the respective sources of the load transistors M2 and M4 are grounded to a GND. A high-level voltage necessary for resetting a charge detection unit is used in the power terminal VDD.

Furthermore, the external signal output unit 2 includes a constant-current circuit unit 40 and a final-stage buffer unit 30. The constant-current circuit unit 40 is an electrical circuit corresponding to the constant-current source unit made up of the load transistor M6 and the resistive element Rss included in the signal output unit within the conventional solid-state image sensor. In the present embodiment, the constant-current circuit unit 40 includes a Junction field-effect transistor (JFET) J1 and a resistive element R4, and forms a source follower circuit by combining with the final-stage drive transistor of the signal output circuit within the solid-state image sensor. The external signal output unit 2 is provided outside of the semiconductor substrate on which the solid-state image sensor 10 is formed.

Furthermore, the final-stage buffer unit 30 is a buffer circuit which outputs image information through the impedance-conversion of an output signal from the output buffer circuit within the solid-state image sensor and the constant-current circuit unit 40, and includes a buffer transistor Q1 and resistive elements R1 and R2.

Furthermore, the Junction field-effect transistor (JFET) J1 has a gate electrode which is grounded to a GND, a source electrode which is connected to a control input terminal via the resistive element R4, and a drain electrode which is connected to an output line of the solid-state image sensor. A control signal VφLG1 is inputted to the control input terminal.

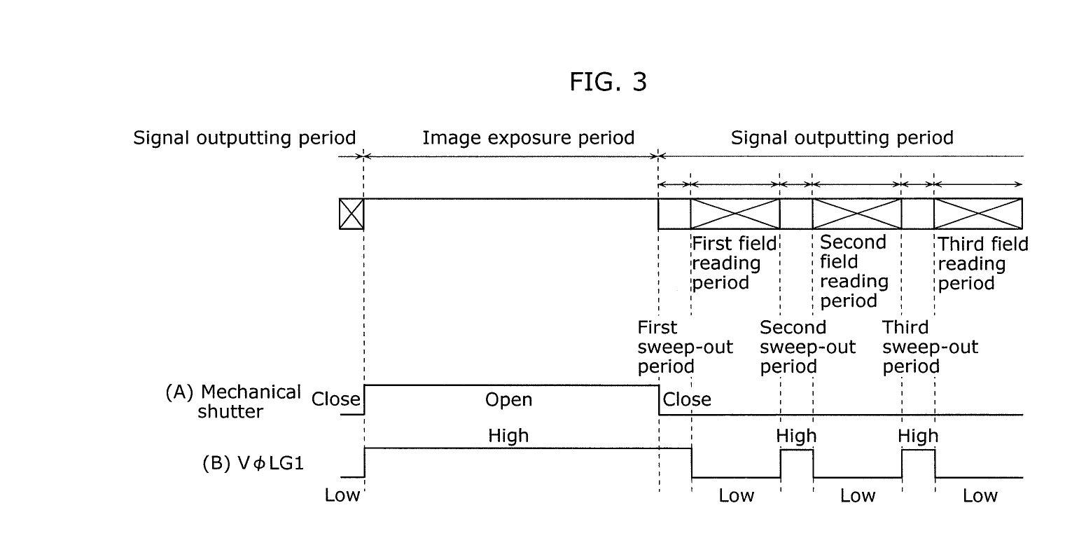

Next, FIG. 3 is an explanatory diagram showing an example of a drive timing for the solid-state imaging device in the first embodiment. (A) shows the operational timing for the mechanical shutter and (B) shows the operational timing for the control signal VφLG1.

First, during an imaging exposure period, as shown in (A), the mechanical shutter is opened and signal charge is accumulated by a light-sensing unit. Subsequently, the mechanical shutter is closed and the signal accumulation is ended.

Furthermore, during the subsequent unnecessary-charge sweep-out period, unnecessary charge remaining in vertical transmission units is swept out by applying a high-speed vertical transmission clock pulse to the vertical transmission units.

In addition, during the subsequent signal outputting period, the vertical transmission units read the signal charge accumulated in the light-sensing unit, and in addition, the vertical transmission units and a horizontal transmission unit transmit and output the signal charge to the signal output unit.

Subsequently, during the imaging exposure period and the unnecessary-charge sweep-out period, as shown in (B), the control signal VφLG1, which is applied to the control input terminal provided in the source electrode of the Junction field-effect transistor (JFET) J1 having a constant-current source, is set to a high bias.

With this, it is possible to cut off the Junction field-effect transistor (JFET) J1 or reduce its drain current, and reduce a source-to-drain voltage Vds, which is the voltage between the source and the drain, of the drive transistor M5.

Specifically, since it is possible to suppress the light emission phenomenon caused by hot electrons and the heat emission in the signal output unit, and reduce differences in the hot electron light emission phenomena and heat emission suppression effectiveness between fields, it is possible to reduce image deterioration due to the localized image whitening and the occurrence of shading caused by the increase in the dark current of light-receiving elements in the vicinity of the signal output unit.

On the other hand, during the signal outputting period excluding the unnecessary-charge sweep-out period, the control signal VφLG1 is set to a Low bias and the Junction field-effect transistor (JFET) 31 is set to ON. With this, during the signal outputting period, it is possible to cause the signal output unit to operate normally, and the signal output operation can be performed at the normal operating point.

Specifically, in the driving described in FIG. 3, the control signal VφLG1 is set to a High level, the voltage applied to the resistive element R4 is lowered, and the current flowing to the signal output unit is kept low in the imaging exposure period, through the drive timing. Furthermore, in the signal outputting period excluding the unnecessary-charge sweep-out period, the drive timing is characterized in setting the control signal VφLG1 to a Low level, increasing the voltage applied to resistive element R4 and passing a current that causes the signal output unit to operate normally.

As described above, the solid-state imaging device described using the Drawings does not perform the CCD signal output operation during the imaging exposure period and the unnecessary-charge sweep-out period of the light-sensing unit.

The solid-state imaging device in the first embodiment of the present invention described using FIG. 1 through FIG. 3 suppresses only the source-to-drain voltage Vds and the current flowing to the final-stage drive transistor M5 included in the signal output unit within the solid-state image sensor during the imaging exposure period and the unnecessary-charge sweep-out period of the light-sensing unit, by directly applying the control signal VφLG1 supplied from a timing generator (TG), to the control input terminal of the constant-current circuit unit 40 provided outside the solid-state image sensor including light-receiving elements, as a control signal for controlling the source-to-drain voltage Vds and the current flowing to the final-stage drive transistor M5.

With this, the source-to-drain voltage Vds of the final-stage drive transistor M5 increases because the majority of the current flowing to the signal output unit flows to the final-stage source follower circuit and, in the signal output circuit configured of the three-stages of source follower circuits, the DC level drops by as much as an amount equal to a Vth amount of the three stages of the drive transistors M1, M3, and M5. The intensity of light emission caused by hot electrons increases in proportion to the size of the Vds.

Based on this, since the impact of the light emission phenomenon caused by hot electrons and the heat emission, on the final-stage source follower circuit is dominating, it is possible to suppress the light emission phenomenon caused by hot electrons and the heat emission in the signal output unit, and reduce differences in hot electron light emission phenomena and heat emission suppression effectiveness between respective fields, and it is possible to reduce image deterioration due to the localized image whitening and the occurrence of shading caused by the increase in the dark current of light-receiving elements in the vicinity of the signal output unit, and thus changes to element characteristics can be kept to the final-stage source follower circuit.

Stated differently, the CCD signal output operation is not performed during the imaging exposure period and the unnecessary-charge sweep-out period of the light-sensing unit.

Therefore, in the present invention, there is no need to maintain an operating point by passing a current for causing the signal output unit to operate, and it is possible to set the control signal VφLG1 to a High bias, cut off or reduce the source current control of the signal output unit, and reduce the source-to-drain voltage Vds of the drive transistor M5, and in the signal outputting period excluding the unnecessary-charge sweep-out period, it is possible to set the control signal VφLG1 to a Low bias so as to increase the current of the signal output unit and thus causing it to operate at a normal operating point.

In addition, the present invention can lower thermal noise by the use of a Junction field-effect transistor (JFET). In addition, by using a Junction field-effect transistor (JFET), the base potential becomes steady at 0V because the base terminal is grounded to a GND, and thus noise can be suppressed. In addition, by using a Junction field-effect transistor (JFET), the number of parts of the circuit can be further reduced compared to the case of using a bipolar transistor, for example.

To sum up the above description, in the present invention, the constant-current source unit of the final-stage source follower circuit which passes the majority of the current flowing to the signal output unit, of the three-stages of source follower circuits included in the signal output unit is provided outside of the solid-state image sensor including light-receiving elements, thereby allowing the amount of heat emitted in the solid-state image sensor to be reduced by as much as the amount of heat emitted by the final-stage constant-current source unit of the signal output unit, and thus allowing the suppression of the increase of localized dark current in the light-receiving elements and the shading which are caused by heat emission in the signal output unit vicinity.

It should be noted that with the technique of providing the current source of the final-stage source follower circuit of the signal output unit outside the solid-state image sensor including the light-receiving elements, characteristic deterioration due to the temperature of the MOS transistor of the source follower circuit included in the signal output unit is remedied through the reduction of the amount of heat emitted. Therefore, output gain improves, the source-to-drain voltage Vds of the drive transistor is reduced, the high electric field in the vicinity of the drain is mitigated to some extent and thus there is also a degree of effectiveness in the suppression of the light emission phenomenon caused by the hot electrons in the transistor. However, there is an insufficient effect on the suppression of localized dark current increase in the light-receiving elements and shading due to the light emission phenomenon caused by hot electrons in the vicinity of the signal output unit.

The reason for this is that with the technique of providing the current source of the final-stage source follower circuit of the signal output unit outside the solid-state image sensor including the light-receiving elements, the high electric field arising due to the size of the source-to-drain voltage Vds does not change by merely reducing the amount of current and reducing current density, and thus it is not possible to sufficiently suppress the light emission phenomenon caused by the hot electrons in the transistor.

Consequently, in the present invention, it is possible to keep the current flowing to the signal output unit low during the imaging exposure period and the unnecessary-charge sweep-out period. In addition, during the signal read out period excluding the unnecessary-charge sweep-out period, the constant-current circuit unit provided outside the light-receiving elements is controlled through the drive timing so that the current that causes the signal output unit to operate normally flows, and thus, during the period in which the current of the constant-current circuit unit is kept low, the current density of the drive transistor of the final-stage source follower circuit is reduced, the source-to-drain voltage Vds is reduced, the high electric field in the vicinity of the drain is mitigated and thus the light emission phenomenon caused by the hot electrons in the transistor can be suppressed in each of the stages.

On the other hand, as a method for correcting image deterioration due to dark current during image processing in an imaging device of a Digital Still Camera (DSC) or a Digital Video Camera (DVC), processing in which, immediately after the imaging operation, the accumulating operation is performed with the imaging elements in the light-shielded state for the same amount of time as in the imaging, and only the image signal for the dark current component is obtained and deducted from the original image-capturing image signal is being used, among others.

Therefore, in the present invention, since the localized increase of dark current in the vicinity of the signal output unit and shading due to the heat emission and the light emission phenomenon caused by the hot electrons in the transistor is significantly suppressed, the saturation output can be increased by much as the decrease in the dark output to be deducted.

In addition, in the present invention, since the current flowing to the signal output unit is kept low during the imaging exposure period and the unnecessary-charge sweep-out period, the lowering of power consumption by the signal output unit during that period can be realized.

It should be noted that, since the problem of heat emission and hot electrons becomes more obvious during a long duration storing mode in which a prolonged signal accumulating operation lasting several seconds or several tens of seconds is performed, in the present invention it is possible to obtain a remarkable effect particularly in a solid-state imaging device which uses a long duration storing mode.

It should be noted that although the present invention uses an n-type transistor, the present invention is not limited to this, and a p-type transistor may also be used.

It should be noted that although the present invention uses a resistive element, the present invention is not limited to this, and a diode-connected transistor may be substituted.

It should be noted that, in the present invention, the configuration of the signal output unit is not limited to the three-stages of source follower circuits using MOS transistors, and other configurations are also acceptable. For example, aside from the three-stage configuration, a configuration with a single-stage or two-stages, or four-stages or more is also acceptable.

It should be noted that, in the present invention, the bias voltage generating circuit is configured so that both ends of the resistive element are short circuited via a fuse element, and the resistance value of the resistive element Rfuse can be adjusted as appropriate, a configuration in which there are no fuse elements on both ends of the resistive element, and the resistance value of the resistive element Rfuse cannot be adjusted is also acceptable. Furthermore, the current source unit CS is not limited to being provided inside the solid-state image sensor, and it may also be provided outside the solid-state image sensor including the light-receiving elements.

It should be noted that although, in the present invention, the control input terminal is provided in the source electrode of the Junction field-effect transistor (JFET) J1, the present invention is not limited to this.

### Second Embodiment

Hereinafter, a solid-state imaging device in a second embodiment of the present invention shall be described. First, the configuration shown for the solid-state imaging device in the present embodiment is the same as that in FIG. 1 except for the parts described in FIG. 3 to be discussed later.

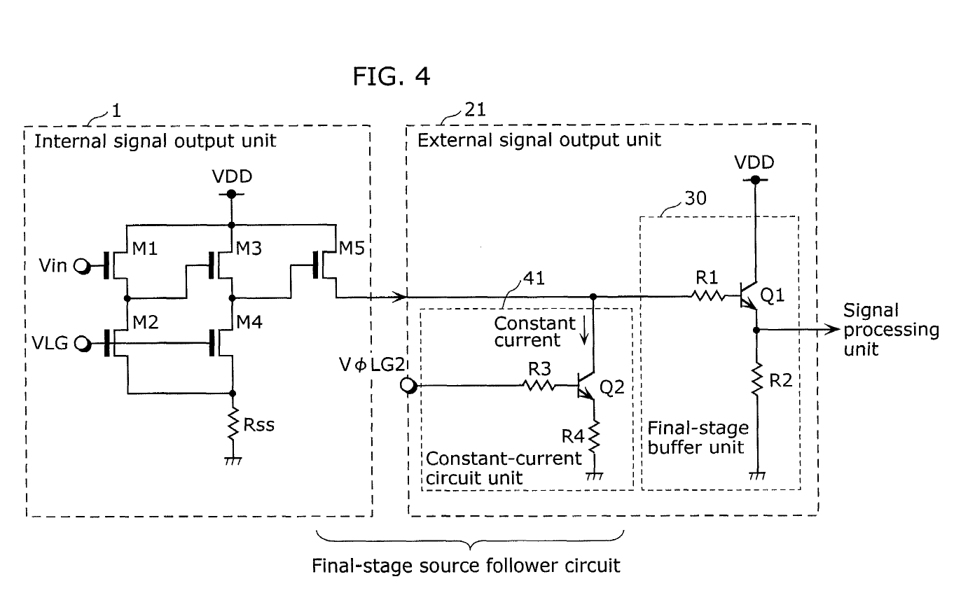

Next, FIG. 4 is an outline diagram showing the configuration of a signal output unit of the solid-state imaging device in the second embodiment of the present invention.

In FIG. 4, the internal signal output unit 1 in a solid-state image sensor including light-receiving elements is configured of three-stages of source follower circuits using the MOS transistors M1 to M5. M1, M3, and M5 are drive transistors and M2 and M4 serve as load transistors which are the current supply units for operating the drive transistors M1 and M3. Furthermore, the drains of the respective drive transistors M1, M3, and M5 are connected to the power terminal VDD. Furthermore, the respective gates of the load transistors M2 and M4 are biased by a constant voltage of the VLG, and the respective sources of the load transistors M2 and M4 are grounded to the GND. A high-level voltage necessary for resetting a charge detection unit is used in the power terminal VDD.

Furthermore, an external signal output unit 21 in the solid-state image sensor includes a constant-current circuit 41 and the final-stage buffer unit 30. The constant-current circuit unit 41 is a electrical circuit corresponding to the constant-current source unit made up of the load transistor M6 and the resistive element Rss included in the signal output unit within the conventional solid-state image sensor. As shown in FIG. 4, the constant-current circuit unit 41 includes a grounded-emitter transistor Q2, the resistive elements R3 and R4, and forms a source follower circuit by combining with the final-stage drive transistor of the signal output circuit within the solid-state image sensor.

Furthermore, the final-stage buffer unit 30 is a buffer circuit which outputs image information through the impedance-conversion of an output signal from the output buffer circuit within the solid-state image sensor and the constant-current circuit unit 41. The final-stage buffer unit 30 includes the buffer transistor Q1 and the resistive elements R1 and R2 Furthermore, the grounded-emitter transistor Q2 is an NPN transistor having a base electrode which is provided with a control input terminal via the resistive element R3, a collector electrode which is connected to an output line of the solid-state image sensor, and an emitter electrode which is connected to a GND via the resistive electrode R4. Here, in view of high frequency driving, it is preferable to use, for the grounded-emitter transistor Q2, a small-sized transistor having low parasitic capacitance between the base and collector, and so on, and excellent frequency characteristics, and so on.

Furthermore, the buffer transistor Q1 is an NPN transistor having a base electrode to which an output signal is applied via the resistive element R1, a collector electrode which is connected to the power terminal VDD, and an emitter electrode which is grounded to a GND via the resistive element R2.

Furthermore, the resistive elements R1 and R3 are resistors for preventing oscillation, and though not necessarily required, they can prevent oscillation which becomes a problem in increasing the speed of output signals, or suppress overshooting and undershooting.

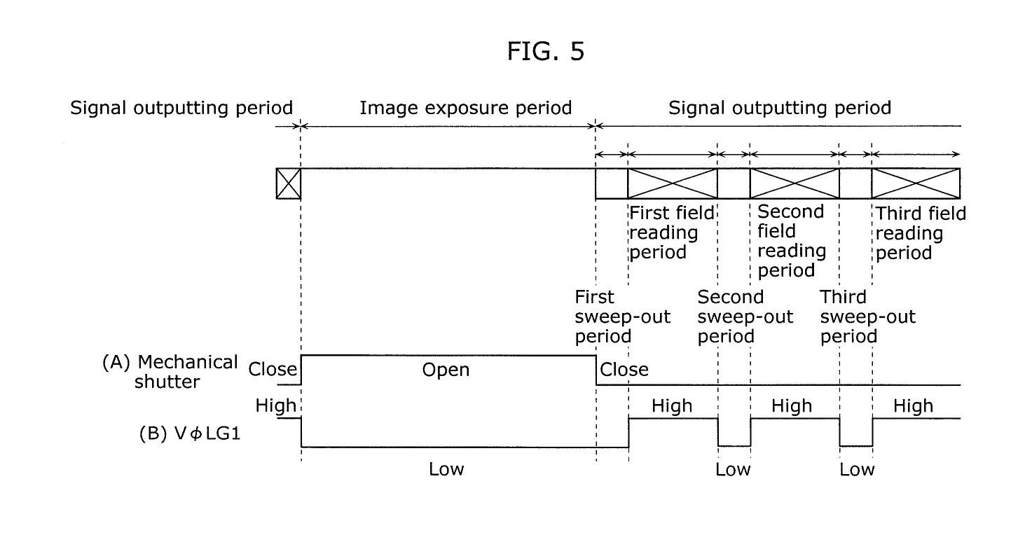

Next, FIG. 5 is an explanatory diagram showing an example of a drive timing for the solid-state imaging device in the second embodiment. (A) shows the operational timing for the mechanical shutter and (B) shows the operational timing for a control signal VφLG2.

In FIG. 5, first, during an imaging exposure period, as shown in (A), the mechanical shutter is opened, signal charge is accumulated by a light-sensing unit, and subsequently the mechanical shutter is closed and the signal accumulation is ended.

Furthermore, during the subsequent unnecessary-charge sweep-out period, unnecessary charge remaining in vertical transmission units is swept out by applying a high-speed vertical transmission clock pulse to the vertical transmission unit.

In addition, during the subsequent signal outputting period, the vertical transmission units read the signal charge accumulated in the light-sensing unit, and in addition, the vertical transmission units and a horizontal transmission unit transmit and output the signal charge to the signal output unit.

Subsequently, during the imaging exposure period and the unnecessary-charge sweep-out period, as shown in (B), the control signal VφLG2, which is applied to the control input terminal provided in the base electrode of the grounded-emitter transistor Q2 having a constant-current source, is set to a Low bias.

With this, it is possible to cut off the grounded-emitter transistor Q2 or reduce its collector current, and reduce the source-to-drain voltage Vds of the drive transistor M5.

Specifically, since it is possible to suppress the light emission phenomenon caused by hot electrons and the heat emission in the signal output unit, and reduce differences in hot electron light emission phenomena and heat emission suppression effectiveness between respective fields, it is possible to reduce image deterioration due to the localized image whitening and the occurrence of shading caused by the increase in the dark current of light-receiving elements in the vicinity of the signal output unit.

On the other hand, during the signal outputting period excluding the unnecessary-charge sweep-out period, the control signal VφLG2 is set to a Low bias and the grounded-emitter transistor Q2 is set to ON. With this, during the signal outputting period, it is possible to cause the signal output unit to operate normally, and the signal output operation can be performed at the normal operating point.

As described above, in the present invention, the CCD signal output operation is not performed during the imaging exposure period and the unnecessary-charge sweep-out period of the light-sensing unit.

With this, in the present invention, there is no need to maintain an operating point by passing a current for causing the signal output unit to operate, and it is possible to set the control signal VφLG2 to a Low bias, cut off or reduce the source current control of the output unit, and reduce the source-to-drain voltage Vds of the drive transistor M5, and in the signal outputting period excluding the unnecessary-charge sweep-out period, it is possible to set the control signal VφLG2 to a High bias so as to increase the current of the output unit and thus causing it to operate at a normal operating point, and an improvement in the effectiveness of suppressing the light emission phenomenon caused by hot electrons and the heat emission can be expected.

In addition, in the present embodiment, by using the grounded-emitter transistor Q2 which is a bipolar transistor, the grounded-emitter transistor Q2 can be made to operate even when the collector-emitter voltage Vce is low, and loss of DC gain can be reduced.

Furthermore, the bipolar transistor also has an advantage of facilitating the designing of the constant-current circuit unit since many are used in the external final-stage buffer circuit.

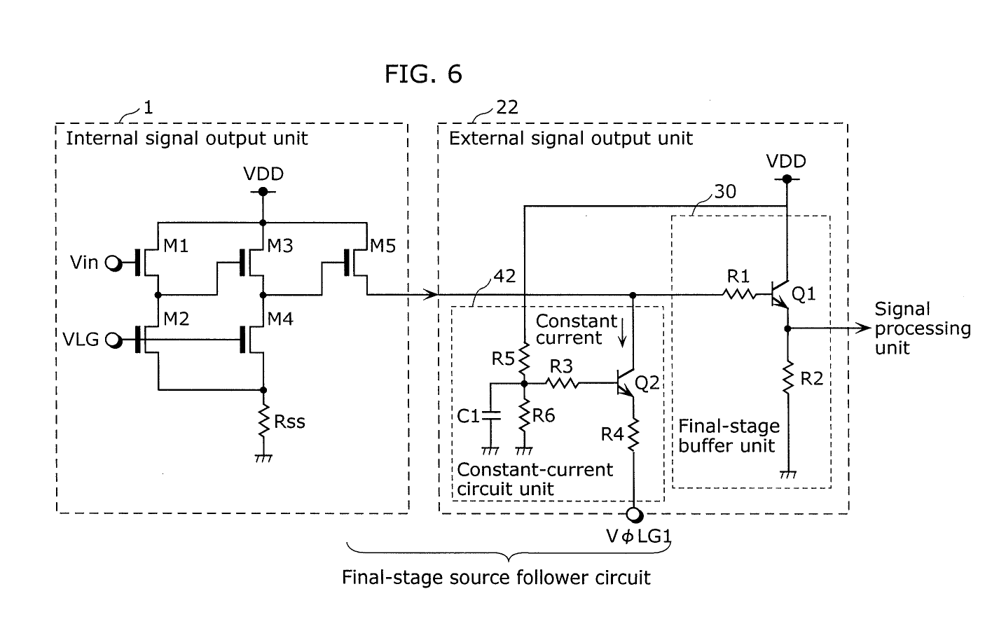

Furthermore, in the present embodiment, by adopting a device configuration as shown in FIG. 6 when a grounded-emitter transistor is used, it is possible to use the same drive as the drive shown in FIG. 3 (first embodiment).

In the drive shown in FIG. 5 (second embodiment), the control signal VφLG2 is applied to the base electrode of the grounded-emitter transistor Q2 included in the constant-current circuit, and thus it is difficult to suppress collector current fluctuation and noise because it is difficult to stabilize the voltage fluctuation in the base electrode. By changing to the configuration shown in FIG. 6, a resistive divider circuit formed by resistors R5 and R6 divides the resistance of a predetermined constant voltage and outputs the divided voltage from a resistive-dividing point, and applies the divided voltage to the base electrode of the grounded-emitter transistor Q2, and, in addition, through the connection of a condenser C1 between the resistive-dividing point of the resistive-divider circuit, the voltage fluctuation in the base electrode can be stabilized and thus the collector current fluctuation and noise can be suppressed more than with the configuration shown in FIG. 4. The driving method in FIG. 3 is effective for the noise suppression of the solid-state imaging device.

Furthermore, with the resistive divider circuit formed by the resistors R5 and R6, the operating point of the constant-current source can be set to the optimal value and the reactive power consumption of a constant-current circuit unit 42 can be made nil.

### Third Embodiment

Hereinafter, a solid-state imaging device in a third embodiment of the present invention shall be described.

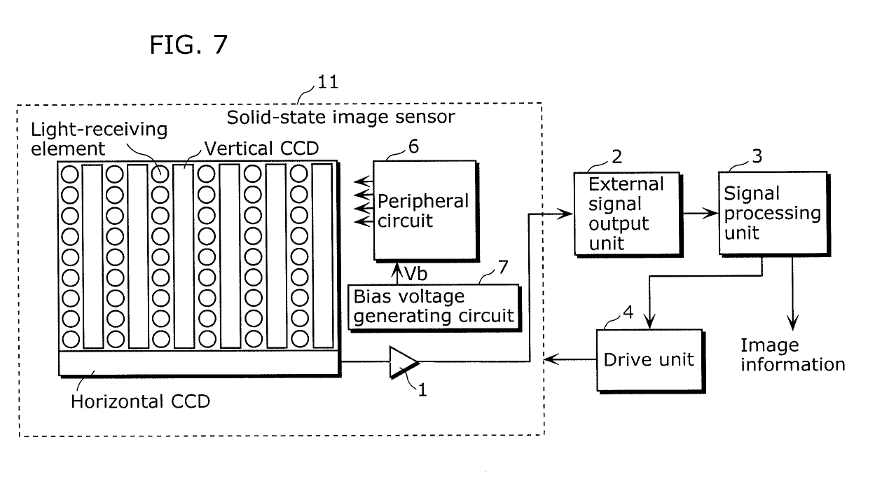

FIG. 7 is an outline diagram showing the configuration of the solid-state imaging device in a third embodiment of the present invention. In the diagram, compared to FIG. 1, a solid-state image sensor 11 is included in place of the solid-state image sensor 10. In the solid-state image sensor 11, a peripheral circuit 6 and a bias voltage generating circuit 7, whose description were omitted in the solid-state image sensor 10, are clearly specified. The peripheral circuit 6 is, for example, a timing generator, and generates horizontal transmission pulses Vφ1 to Vφ6, and horizontal pulses Hφ1 and Hφ2. The bias voltage generating circuit 7 generates a bias voltage and supplies this to the peripheral circuit 6.

It should be noted that the remaining device configuration is the same as in the solid-state imaging device in the second embodiment described using FIG. 4.

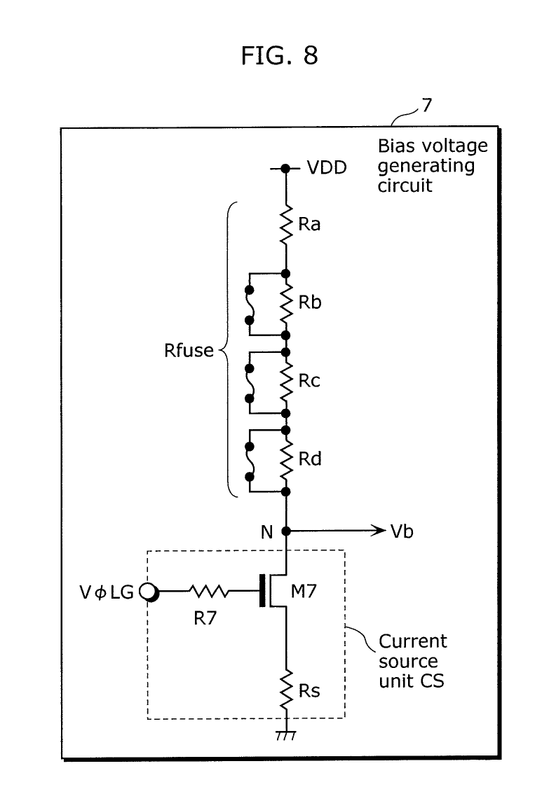

FIG. 8 is an outline diagram of the configuration of the bias voltage generating circuit 7.

In FIG. 8, the bias voltage generating circuit 7 includes, as main components, the resistive element Rfuse and the current source unit CS. The resistive element Rfuse is made up of the resistive elements Ra, Rb, Rc, and Rd which are connected in series between the power terminal VDD and a bias voltage generation point N. Both ends of the resistive element Rb are short circuited via a fuse element. The same is true for the resistive terminals Rc and Rd. By selectively cutting off these fuse elements, the resistance value of the resistive element Rfuse is adjusted as appropriate.

Furthermore, the current source unit CS includes the load transistor M7, and resistive elements Rs and R7. The drain electrode of the load transistor M7 is connected to the bias voltage generation point N, and its source electrode is grounded to GND via the resistive element Rs. A control input terminal is provided in the gate electrode of the load transistor M7 via a resistive element Rg, and the control signal VφLG2 described in FIG. 5 is applied at the same operational timing.

Furthermore, as for the electrical characteristics of the resistive elements Rfuse, Rs, and the load transistor M7, since the control signal VφLG2 is set to a Low bias during the imaging exposure period and the unnecessary-charge sweep-out period, as shown in FIG. 5, it is possible to cut off the load transistor or reduce its drain current.

With this, it is possible to suppress the light emission phenomenon caused by hot electrons and the heat emission in the bias voltage generating circuit, and reduce differences in hot electron light emission phenomena and heat emission suppression effectiveness between respective fields.

On the other hand, during the signal outputting period excluding the unnecessary-charge sweep-out period, the control signal VφLG2 is set to a High bias and the load transistor M7 is set to ON, a reference current flows in the resistive element Rfuse, and it becomes possible to generate a voltage Vb which drops from the voltage applied to the power terminal VDD by as much as the voltage obtained by multiplying the reference current and the resistive element Rfuse, and the bias voltage generating circuit can be set to a normal operating state.

However, in a substrate bias voltage generating device which influences the spectral characteristics of a photodiode during the image exposure period, it is assumed that a control input terminal is not included and the reference current flows at all times, in the same manner as what is conventional.

As described above, the solid-state imaging device and the driving method thereof in the third embodiment of the present invention described in FIG. 8 are characterized in that the bias voltage generating circuit and the current source, aside from the signal output unit, are also provided with a control input terminal in the same manner, and the light emission phenomenon caused by hot electrons and the heat emission are suppressed through the control signal VφLG2.

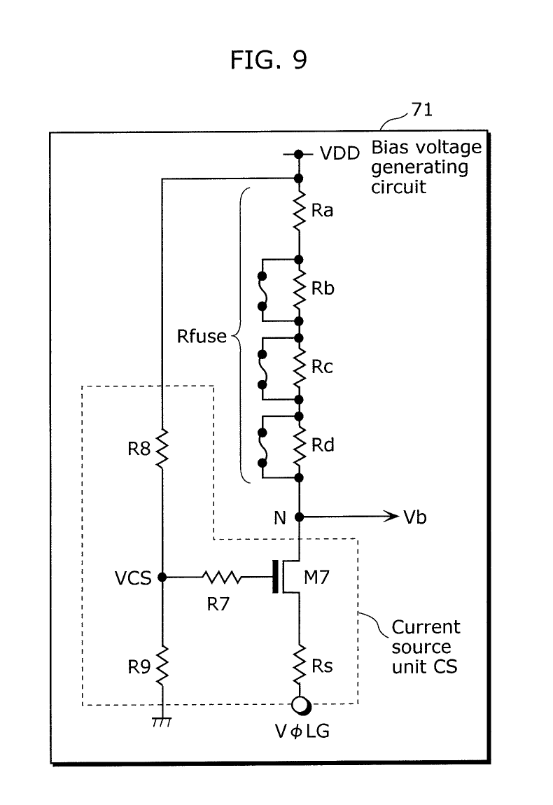

It should be noted that, in the present embodiment, by adopting a device configuration as shown in FIG. 9, it is possible to use the same drive as the drive shown in FIG. 3 (first embodiment).

In the drive shown in FIG. 5 (second embodiment), the control signal VφLG2 is applied to the gate electrode of the load transistor M7 included in the constant-current circuit, and thus it is difficult to suppress drain current fluctuation and noise because it is difficult to stabilize the voltage fluctuation in the gate electrode. By changing to the configuration shown in FIG. 9, the control signal VφLG1 is applied to the source of the load transistor M7 via the resistive element Rs. Since a resistive divider circuit formed by resistors R8 and R9 divides the resistance of a predetermined constant voltage and outputs the divided voltage from a resistive-dividing point, and applies the divided voltage to the gate electrode of the load transistor M7, the voltage fluctuation in the gate electrode can be stabilized and thus the collector current fluctuation and noise can be suppressed more than with the configuration shown in FIG. 4. The driving method in FIG. 3 is effective for the noise suppression of the solid-state imaging device.

Furthermore, with the resistive divider circuit formed by the resistors R8 and R9, the operating point of the constant-current source can be set to the optimal value and the reactive power consumption of a constant-current source can be made nil.

Although the solid-state image sensor in the present invention has been described thus far based on the first through third embodiments, the present invention is not limited to these embodiments. Other embodiments that are realized by combining arbitrary constituent elements in the respective embodiments, modifications obtained by executing various variations on the respective embodiments without departing from the fundamentals of the present invention, and various devices in which the solid-state image sensor in the present invention is built-in are included in the present invention.

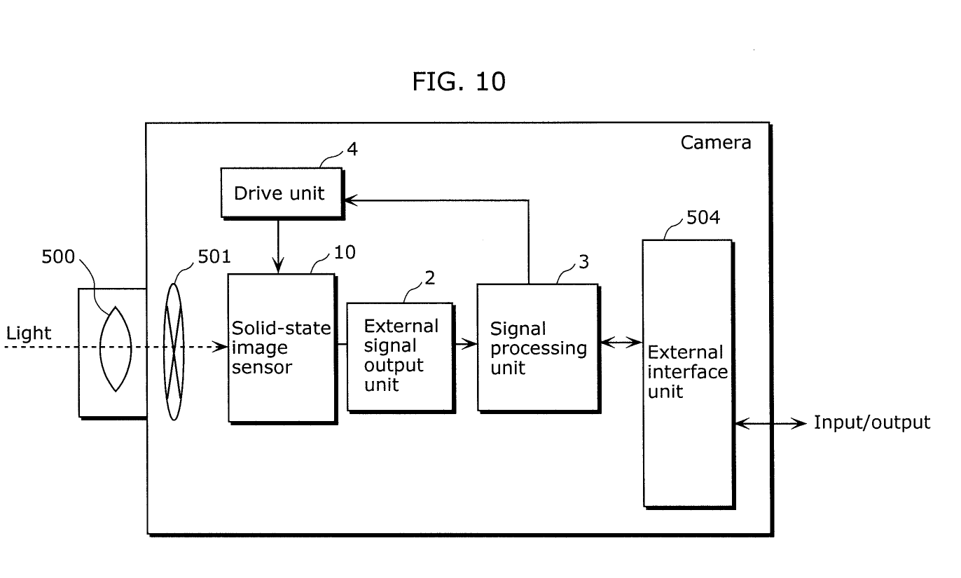

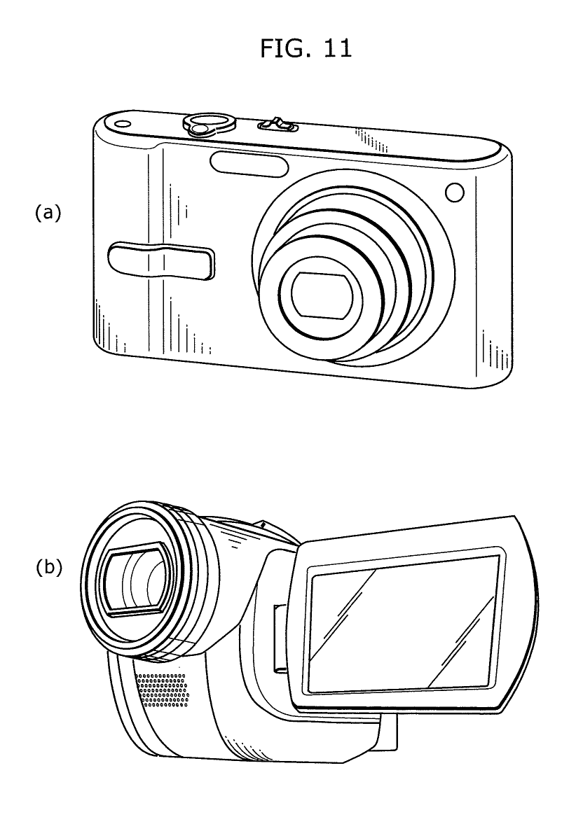

For example, the present invention includes a camera in which the solid-state image sensor 10, the external signal output unit 2, the signal processing unit 3, and the driving unit 4 in the present invention are built-in, as shown in FIG. 10. This camera includes a lens 500, a mechanical shutter 501, the solid-state image sensor 10, the external signal output unit 2, the signal processing unit 3, the driving unit 4, and an external interface unit 504. Light passing through the lens 500 enters the solid-state imaging sensor 10. The signal processing unit 3 drives the solid-state image sensor 10 via the driving unit 4, and takes the output signal from the solid-state image sensor 10. Such output signal undergoes various signal processing through the signal processing unit 3 and is outputted via the external interface unit 504. Here, the solid-state image sensor 10 is driven as in FIG. 3 or FIG. 5. Such a camera can obtain images of low-noise and low-shading, and is realized as the digital still camera or the video camera shown in FIG. 11.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The solid-state imaging device and the driving method thereof in the present invention can be used in a Digital Still Camera (DSC), a Digital Video Camera (DVC), a digital camera, and so on.

What is claimed is:

1. A solid-state imaging device comprising:
a solid-state image sensor in which light-receiving elements are arrayed;
an output circuit which includes at least one stage of a source follower circuit, and which receives a signal from each of said light receiving elements and outputs the received signal; and
a buffer circuit which buffers with impedance conversion, an output signal from a source follower circuit which is a final stage in said output circuit,
wherein said final-stage source follower circuit in said output circuit includes a drive transistor and a load transistor connected to said drive transistor, and
a source-to-drain voltage of said drive transistor in the final stage during a first period is made lower than the source-to-drain voltage during a second period by applying, to said load transistor, a control signal having a different level for the first period and the second period, the first period including a charge sweep-out period and an exposure period of said light-receiving elements in a signal outputting period, and the second period being a period excluding the charge sweep-out period from the signal outputting period.

2. The solid-state imaging device according to claim 1,
wherein said load transistor of said final-stage source follower circuit and said buffer circuit are provided outside a semiconductor substrate on which said solid-state image sensor is formed.

3. The solid-state imaging device according to claim 1,
wherein said load transistor is a Junction Field-Effect Transistor,
a gate of said load transistor is grounded,
a drain of said load transistor is connected to an output signal line connected to a source of said drive transistor in the final stage,
a source of the load transistor is connected to a control signal line for transmitting the control signal, and
the control signal is a pulse signal which has a high level during the first period and has a low level during the second period.

4. The solid-state imaging device according to claim 1,
wherein said load transistor is a bipolar transistor,
a collector of said load transistor is connected to an output signal line connected to a source of said drive transistor in the final stage,
an emitter of said load transistor is grounded,
a base of the load transistor is connected to a control signal line for transmitting the control signal, and
the control signal is a pulse signal which has a low level during the first period and has a high level during the second period.

5. The solid-state imaging device according to claim 2,
wherein said output circuit further includes, outside said semiconductor substrate, a resistive divider circuit which generates a constant voltage by resistive division,
said load transistor is a bipolar transistor,
a collector of said load transistor is connected to an output signal line connected to a source of said drive transistor in the final stage,
an emitter of said load transistor is connected to a control signal line for transmitting the control signal,
a base of the load transistor is supplied with the constant voltage from said resistive divider circuit, and
the control signal is a pulse signal which has a high level during the first period and has a low level during the second period.

6. The solid-state imaging device according to claim 2, further comprising
a bias voltage generating circuit which is provided on said semiconductor substrate, and which supplies a bias voltage to a peripheral circuit of said solid-state image sensor,
wherein said bias voltage generating circuit includes a resistive circuit and a current source transistor and outputs the bias voltage from a connection point between said resistive circuit and said current source transistor, said resistive circuit and said current source transistor being connected in series between a power line and a grounding line, and
a current of said current source transistor during a first period is made less than the current of said current source transistor during a second period by applying, to said current source transistor, the control signal having a different level for the first period and the second period.

7. The solid-state imaging device according to claim 2, further comprising
a bias voltage generating circuit which is provided outside said semiconductor substrate, and which supplies a bias voltage to a peripheral circuit of said solid-state image sensor,
wherein said bias voltage generating circuit includes a resistive circuit and a current source transistor and outputs the bias voltage from a connection point between said resistive circuit and said current source transistor, said resistive circuit and said current source transistor being connected in series between a power line and a grounding line, and
a current of said current source transistor during a first period is made less than the current of said current source transistor during a second period by applying, to said current source transistor, the control signal having a different level for the first period and the second period.

8. A driving method for use in a solid-state imaging device including a solid-state image sensor in which light-receiving elements are arrayed, an output circuit which includes at least one stage of a source follower circuit and which receives a signal from each of the light receiving elements and outputs the received signal, and a buffer circuit which outputs, by impedance conversion, an output signal from a source follower circuit which is a final stage in the output circuit,
wherein the final-stage source follower circuit in the output circuit includes a drive transistor and a load transistor connected to the drive transistor,
said driving method comprises:
applying a control signal to the load transistor during a first period which includes a charge sweep-out period and an exposure period of the light-receiving elements in a signal outputting period; and
applying a control signal to the load transistor during a second period which is a period excluding the charge sweep-out period from the signal outputting period, and
a source-to-drain voltage of the drive transistor in the final stage during the first period is made lower than the source-to-drain voltage during the second period.

9. A camera comprising the solid-state imaging device in claim 1.
